(19) United States
(12) Patent Application Publication
(10) Pub. No.: US 2013/0149055 A1
(43) Pub. Date: Jun. 13, 2013

(54) MACHINE TOOL

(71) Applicant: Peter T.H. Tsai, Taipei City (TW)

(72) Inventor: Peter T.H. Tsai, Taipei City (TW)

(73) Assignee: ALEX-TECH MACHINERY INDUSTRIAL CO., LTD., Taichung City (TW)

(21) Appl. No.: 13/468,061

(22) Filed: May 10, 2012

(30) Foreign Application Priority Data
Dec. 13, 2011 (TW) 100145956

(51) Int. Cl. B23Q 1/26; B23Q 1/70

(52) U.S. Cl. 408/13; 408/88

(57) ABSTRACT

A machine tool includes a crossbeam which is movably mounted on a column in an upright direction and on which a spindle carriage is transversely slidably mounted for mounting a spindle. The crossbeam extends transversely to terminate at a cantilever portion which extends rightwardly and beyond the column. A hydraulic bracing unit is mounted to brace the cantilever portion so as to stabilize the vertical movement of the crossbeam, while preventing the crossbeam from being subjected to bending stress even when the saddle is moved to the cantilever portion.

### CROSS-REFERENCE TO RELATED APPLICATION

This application claims priority of Taiwanese Patent Application No. 100145956, filed on Dec. 13, 2011, the disclosure of which is herein incorporated by reference.

### BACKGROUND OF THE INVENTION

1. Field of the Invention

This invention relates to a machine tool, more particularly to a vertical machine tool having a crossbeam which is displaceable in an upright direction to raise or lower a spindle carriage.

2. Description of the Related Art

Referring to FIG. 1, a conventional vertical machine tool 10 is shown to include a column 11 which extends in an upright direction from a machine base (not shown), and which has a pair of uprightly extending guide rails 111, a crossbeam 12 having a guided portion 123 which is slidably engaged with the guide rails 111 and which is moved in the upright direction by rotation of a vertical worm gear 113 driven by a drive motor 112, a saddle 13 which is disposed on and movable relative to the crossbeam 12 in a transverse direction by rotation of a transverse worm gear 122 driven by a servomotor 121, and a spindle carriage 14 which is disposed on the saddle 13 for rotatably supporting a spindle 141.

In order to machine a relatively long workpiece, the crossbeam 12 extends transversely to terminate at a cantilevered portion 124 that projects laterally from the column 11 so as to permit the saddle 13 to be moved to the cantilever portion 124 for positioning a tool on the spindle 141 above the part of the workpiece to be machined. However, the combined weight of the saddle 13, the spindle carriage, the servomotor 121, etc., may cause the cantilevered portion 124, even the entire machine tool 10, to tilt to one side, which may result in incorrect and defective machining.

### SUMMARY OF THE INVENTION

An object of the present invention is to provide a machine tool in which a crossbeam is positioned steadily and firmly at a predetermined height position.

According to this invention, the machine tool includes a machine base having front and rear portions opposite to each other in a longitudinal direction, a worktable which is disposed on the front portion and which has a tabletop for supporting a workpiece, a column which extends in an upright direction from the rear portion and which has at least one guide rail that extends in the upright direction and that faces forwardly, and a crossbeam having a left guided portion which is slidably engaged with the guide rail to be movable in the upright direction relative to the column. The crossbeam is configured to extend in a transverse direction relative to the longitudinal and upright directions from the left guided portion to terminate at a right cantilever portion that extends rightwardly and beyond the column and that is disposed outwardly and rightwardly of the machine base. A saddle is disposed on and movable relative to the crossbeam in the transverse direction. A spindle carriage is disposed on the saddle above the tabletop for rotatably supporting a spindle. A hydraulic bracing unit includes a hydraulic cylinder which is adapted to stand on the ground surface, and a piston rod which is movably disposed relative to the hydraulic cylinder and which braces the right cantilever portion so as to permit the piston rod to be moved in synchronization with the left guided portion, thereby stabilizing displacement of the crossbeam in the upright direction, while preventing the crossbeam from being subjected to bending stress when the saddle is moved to the right cantilever portion.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view of a conventional vertical machine tool;

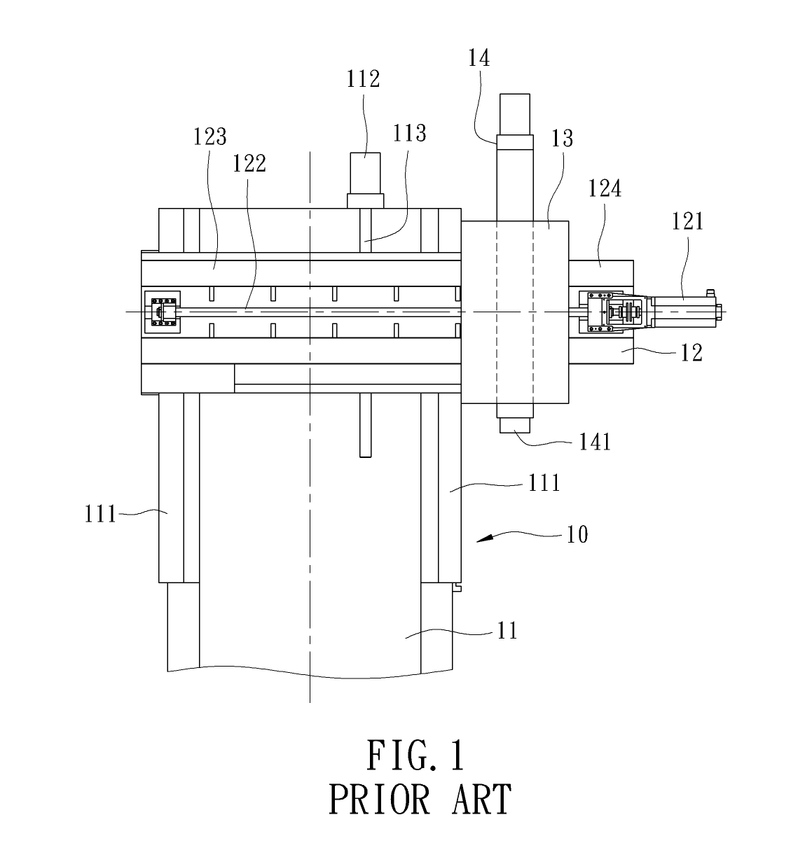

FIG. 2 is a perspective view of the preferred embodiment of a machine tool according to this invention;

FIG. 3 is a perspective view of the preferred embodiment taken from a bottom side thereof;

FIG. 4 is a front view of the preferred embodiment;

FIG. 5 is a perspective view of the preferred embodiment taken from a backside thereof;

FIG. 6 is a front view of the preferred embodiment in a state where a saddle is moved to a cantilever portion of a crossbeam; and

FIG. 7 is a perspective view similar to FIG. 5 in a state where the saddle is moved to the cantilever portion.

### DETAILED DESCRIPTION OF THE PREFERRED EMBODIMENT

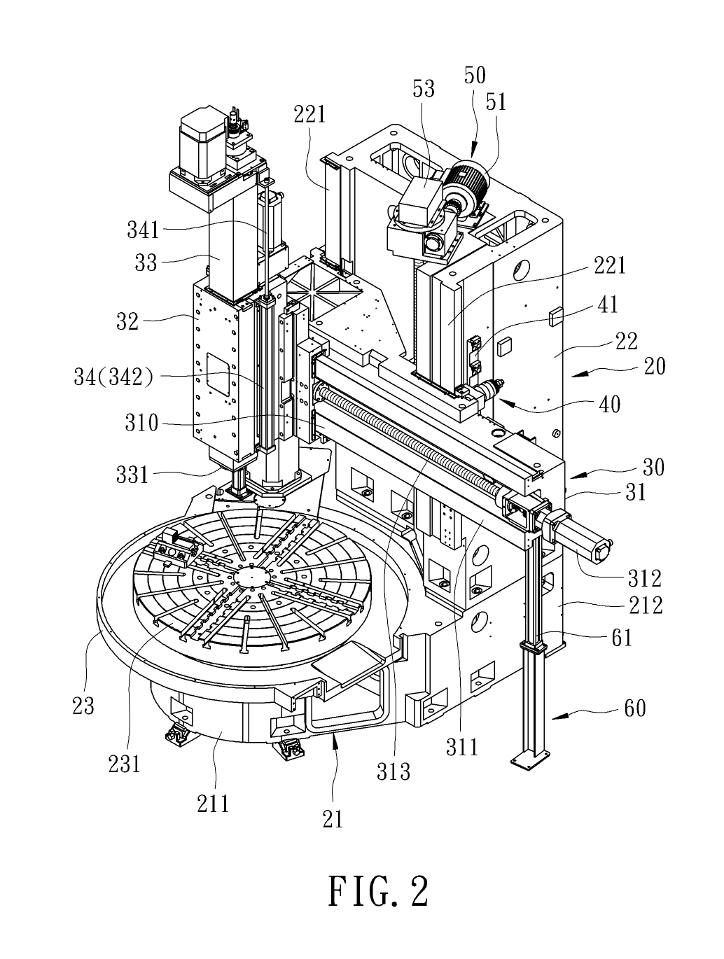

Referring to FIGS. 2 to 4, the preferred embodiment of a machine tool 20 according to the present invention is shown to comprise a machine base 21 having front and rear portions 211, 212 opposite to each other in a longitudinal direction, a worktable 23 disposed on the front portion 211 and having a tabletop 231 for supporting a workpiece (not shown) , and a column 22 which extends in an upright direction from the rear portion 212 and which has a pair of guide rails 221 that extend in the upright direction and that face forwardly.

The machine tool 20 further comprises a crossbeam unit 30, a crossbeam positioning unit 40, a crossbeam driving unit 50, and a hydraulic bracing unit 60.

The crossbeam unit 30 includes a crossbeam 31 having a left guided portion 310 which is slidably engaged with the guide rails 221 to be movable in the upright direction relative to the column 22, a saddle 32 disposed on and movable relative to the crossbeam 31 in a transverse direction relative to the longitudinal and upright directions, a spindle carriage 33 disposed on the saddle 32 above the tabletop 231 for rotatably supporting a spindle 331, and two spindle driving units 34 configured to permit quick movement of the spindle carriage 33 relative to the saddle 32 in the upright direction. The crossbeam 31 is configured to extend in the transverse direction from the left guided portion 310 to terminate at a right cantilever portion 311 that extends rightwardly and beyond the column 22 and that is disposed outwardly and rightwardly of the machine base 21. A servomotor 312 is mounted on the cantilever portion 311. A transverse worm gear 313 is disposed along the crossbeam 31 and is engaged with the saddle 32 so as to drive the transverse movement of the saddle 32 in the transverse direction. Each of the spindle driving units 34 includes a pneumatic/hydraulic cylinder 342 disposed on the saddle 32, and a piston rod 341 which is movably disposed relative to the pneumatic/hydraulic cylinder 342 and which is connected to the spindle carriage 33. For example, the pneumatic/hydraulic cylinder 342 is a pneumatic and hydraulic cylinder in which nitrogen is used as a working fluid so as to quickly move the spindle carriage 33 in the upright direction.

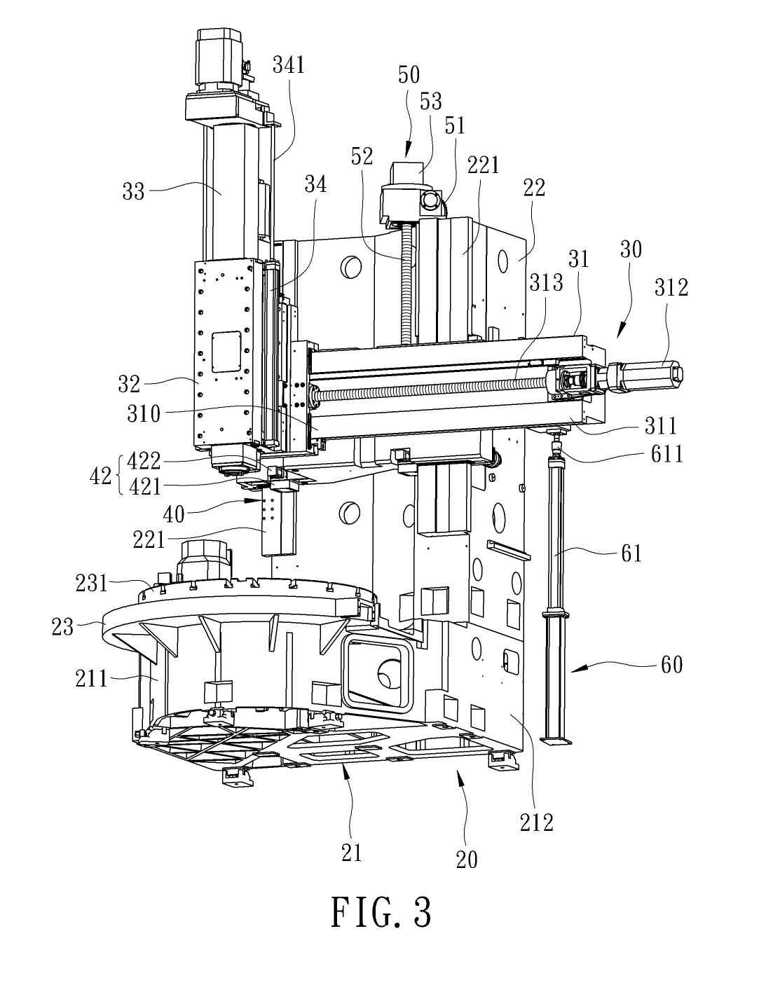

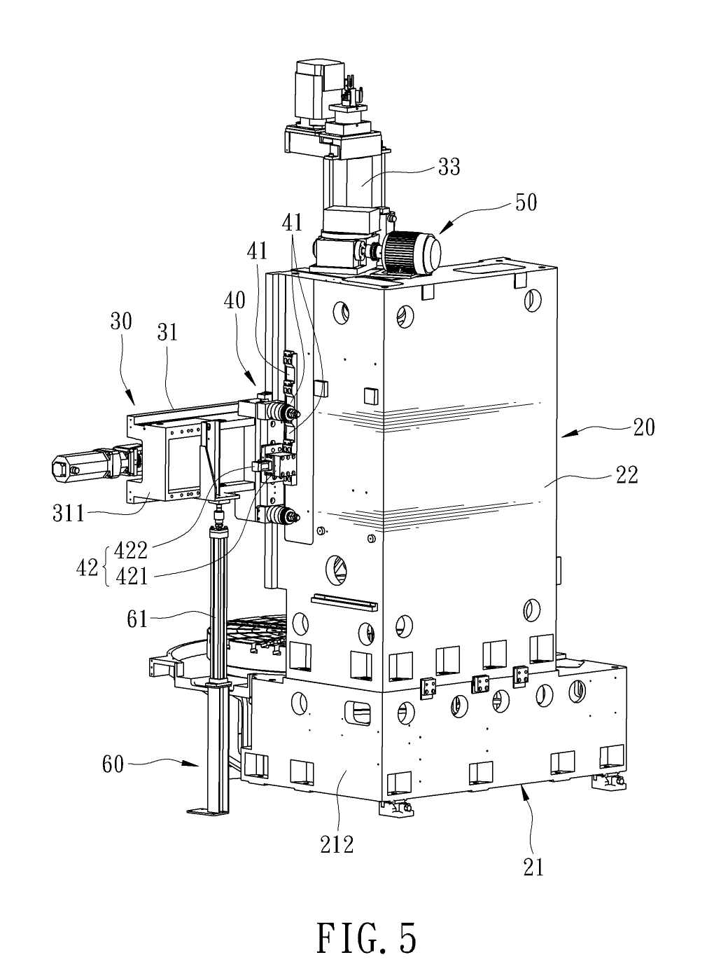

Referring to FIGS. 3 and 5, the crossbeam positioning unit 40 includes two sets of retained grooves 41 which are disposed in the column 22 adjacent to the guide rails 221, respectively, and two retaining members 42 which are disposed on the left guided portion 310 of the crossbeam 31. The retained grooves 41 of each set are displaced from one another in the upright direction. Each of the retaining members 42 includes an actuator 421 and a retaining pin 422 displaceable relative to the left guided portion 310. During the vertical movement of the crossbeam 31, a sensing signal is generated as a result of detection of a reach to a predetermined one of the retained grooves 41, and the actuator 421 is activated to actuate displacement of the retaining pin 422 to engage the predetermined retaining groove 41. Therefore, the crossbeam 33 can be retained precisely at a predetermined height position.

The crossbeam driving unit 50 includes a drive motor 51 which is disposed on the column 22, a worm gear having a threaded shaft 52 which is driven by the drive motor 51 through a speed-reducing mechanism 53 and which is disposed to transmit a rotational drive to move the crossbeam 31 in the upright direction.

The hydraulic bracing unit 60 includes a hydraulic cylinder 61 which is adapted to stand on the ground surface, and a piston rod 611 which is movably disposed relative to the hydraulic cylinder 61 and which braces the right cantilever portion 311 so as to permit the piston rod 611 to be moved in synchronization with the left guided portion 310, thereby stabilizing the vertical displacement of the crossbeam 31 in the upright direction.

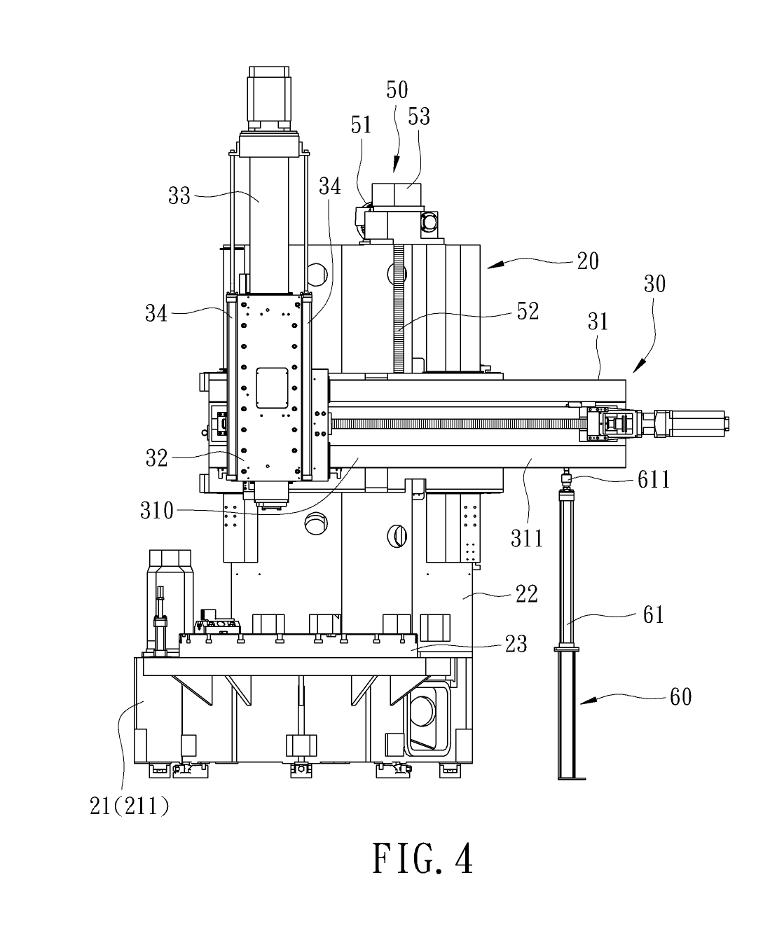

As shown in FIGS. 4 and 5, which illustrate the state where the saddle 32 and the spindle carriage 33 are located at the left guided portion 310 of the crossbeam 31, the crossbeam 31, the saddle 32 and the spindle carriage 33 are supported on the column 22 by means of the crossbeam positioning unit 40 for performing a steady machining process.

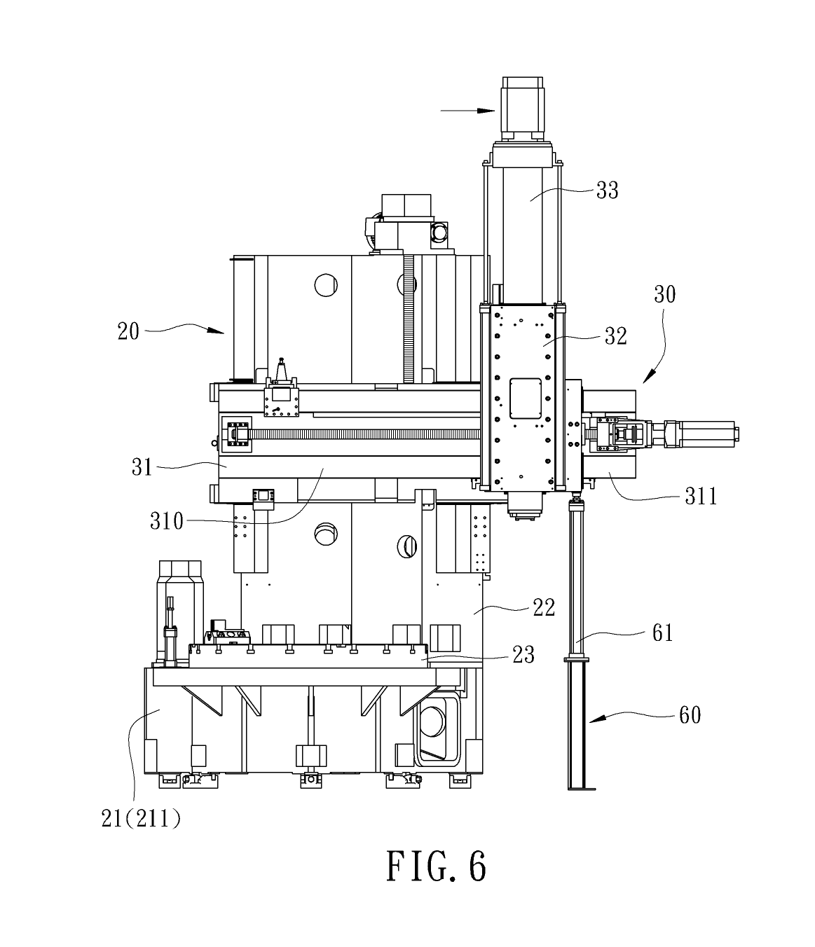

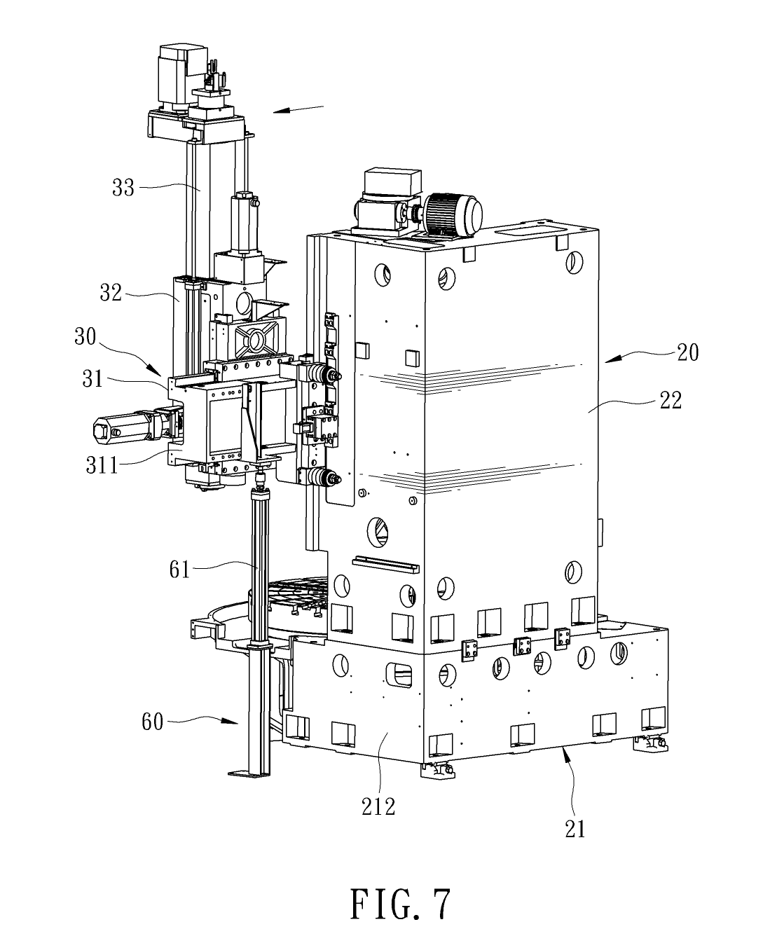

As shown in FIGS. 6 and 7, when the saddle 32 is moved to the right cantilever portion 311 of the crossbeam 31, the heavy load exerted by the saddle 32 and the spindle carriage 33 to the right cantilever portion 311 can be borne by the hydraulic bracing unit 60 so as to prevent the crossbeam 31 from being subjected to the resulted bending stress. Thus, a steady and precise machining process can be performed on the machine tool of this invention.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A machine tool comprising:
a machine base having front and rear portions opposite to each other in a longitudinal direction;
a worktable disposed on said front portion and having a tabletop for supporting a workpiece;
a column extending in an upright direction from said rear portion and having at least one guide rail which extends in the upright direction and which faces forwardly;
a crossbeam having a left guided portion which is slidably engaged with said guide rail to be movable in the upright direction relative to said column, said crossbeam being configured to extend in a transverse direction relative to the longitudinal and upright directions from said left guided portion to terminate at aright cantilever portion that extends rightwardly and beyond said column and that is disposed outwardly and rightwardly of said machine base;
a saddle disposed on and movable relative to said crossbeam in the transverse direction;
a spindle carriage disposed on said saddle above said tabletop for rotatably supporting a spindle; and
a hydraulic bracing unit including a hydraulic cylinder which is adapted to stand on the ground surface, and a piston rod which is movably disposed relative to said hydraulic cylinder and which braces said right cantilever portion so as to permit said piston rod to be moved in synchronization with said left guided portion, thereby stabilizing displacement of said crossbeam in the upright direction.

2. The machine tool as claimed in claim 1, further comprising:
a plurality of retained grooves disposed in said column adjacent to said guide rail and displaced from one another in the upright direction; and
at least one retaining member which is disposed on and displaceable relative to said left guided portion of said crossbeam, and which is activated upon a sensing signal generated as a result of detection of a reach to a predetermined one of said retained grooves to displace to engage the predetermined one of said retained grooves.

3. The machine tool as claimed in claim 2, further comprising a crossbeam driving unit including a drive motor which is disposed on said column, a worm gear having a threaded shaft which is driven by said drive motor through a speed-reducing mechanism and which is disposed to transmit a rotational drive to move said crossbeam in the upright direction.

4. The machine tool as claimed in claim 3, further comprising at least one spindle driving unit which is configured to permit quick movement of said spindle carriage relative to said saddle in the upright direction.

5. The machine tool as claimed in claim 4, wherein said spindle driving unit includes a pneumatic cylinder disposed on s aid saddle, and a piston rod which is movably disposed relative to said pneumatic cylinder and which is connected to said spindle carriage.
